(19) United States
(12) Patent Application Publication
(10) Pub. No.: US 2005/0155570 A1
(43) Pub. Date: Jul. 21, 2005

(54) Tumble control valve having a bottom pivot

(76) Inventors: Keith A. Confer, Flushing, MI (US); Curtis D. Lamb, Scottsville, NY (US)

Correspondence Address: JIMMY L. FUNKE, ESQ.;DELPHI TECHNOLOGIES, INC., MAIL CODE 480410202, P.O. BOX 5052, TROY, MI, 48007, US

(21) Appl. No.: 10/762,168

(22) Filed: Jan. 21, 2004

(51) Int. Cl. F02B 31/06

(52) U.S. Cl. 123/306; 123/184.56

(57) ABSTRACT

A tumble valve for variably impeding air flow in a manifold runner of an internal combustion engine. The valve includes a pivot-shaft located at or in a wall of the runner. The runner is rectanguloid in the region of the pivot-shaft, as is a damper attached along one edge to the pivot-shaft. In closed position, the valve creates a desired degree of tumble in air flowing through the runner, but in open position the shaft and damper lie against the runner wall. The improved valve thus causes no air flow restriction when the valve is open. In any partially-closed position, the lower area of the runner is always blocked because the valve pivots from below, and all air is forced up and over the upper edge of the damper. Fuel efficiency is optimized over an increased range of engine speeds.

### TECHNICAL FIELD

The present invention relates to internal combustion engines; more particularly, to devices for inducing flow tumble in intake manifold runners for internal combustion engines; and most particularly, to a tumble control rotary valve having a pivot at a lower edge.

### BACKGROUND OF THE INVENTION

Multiple cylinder internal combustion engines are well known. Such an engine typically includes an intake air manifold for collecting combustion air through a common intake valve into a plenum and distributing the air to each of the individual combustion cylinders via air channels known in the art as “runners.” Intake manifolds are intended to optimize the flow of air into the cylinders through appropriate plenum volume and shape, runner lengths and cross-sectional shapes, and overall manifold layout and geometry. Typically, a manifold has a fixed geometry that is optimized for a certain range of engine speeds and thus represents a compromise for other conditions. So-called active tuned manifolds employ valves or other active elements to overcome or reduce such compromises by dynamically changing the manifold geometry to be more closely optimized for each operating condition.

One known type of active tuning involves dynamically changing the geometry in one or more of the manifold runners to induce added turbulence into air flowing through the runners at a point just ahead of the intake valves. Such turbulence is known in the art as “tumble.” Added tumble improves the in-cylinder mixing of air and fuel and thus promotes more efficient combustion.

In the prior art, tumble is typically induced by placing a movable valve, such as a rotary valve having a “butterfly” damper, in the runner and rotating the valve to partially block the air passage in the runner. Typically, the valve cross-shaft is asymmetrically disposed on the butterfly damper such that when the valve is forced closed the bottom section of the runner is blocked, forcing the air to flow up and over the upper part of the valve. The air, after being biased to the top of the runner, enters the cylinder in a manor that causes the charge to tumble around an axis perpendicular to the centerline of the engine cylinder. In a typical prior art multi-cylinder engine, each of the runners includes a tumble valve, and several individual valves share a common pivotable cross-shaft that runs through the centers of the runners. Pivoting this shaft allows the valves to be rotated together from an open position, wherein the butterflies are aligned with the direction of air flow, to a closed position, wherein the butterflies are perpendicular to the flow direction. Typically, each butterfly damper is shaped such that, in fully closed position, the damper does not fully occlude the runner. The top section of the runner remains open to flow while the middle and bottom sections are closed to flow.

Although a prior art tumble valve can induce tumble in the closed position, a shortcoming of such a valve is that it creates an unwanted air flow restriction when in the open position. Such a flow restriction reduces engine efficiency and power. Flow losses in prior art engines may be as high as 15% of the possible total air flow at wide open engine throttle.

What is needed in the art is a runner tumble valve that can provide required degrees of air tumble when desired and can also cause little or no tumble or air flow restriction when no tumble is required.

It is a principal object of the present invention to improve the fuel efficiency and power of an internal combustion engine.

### SUMMARY OF THE INVENTION

Briefly described, a tumble valve in accordance with the invention for variably impeding air flow in a manifold runner includes a pivot-shaft located at, or recessed into, a wall of the runner. Preferably, the cross-sectional shape of the runner in the region of the pivot-shaft is generally rectangular or rectanguloid. A similarly rectangular or rectanguloid butterfly damper is attached along one edge thereof to the pivot-shaft.

This shaft location allows the valve to be closed to a position that creates a desired degree of tumble in air flowing through the runner, but also allows the shaft and damper to be recessed to or into the runner wall when in the open position. Recessing the valve thusly eliminates any parasitic flow restriction when the valve is open, as the shaft and damper are not in the flow path. A valve in accordance with the invention is a further improvement over the prior art in that, in any partially-closed position, the lower area of the runner is always blocked because the valve pivots from below. All air is forced up and over the upper edge of the damper, thus increasing tumble over that obtainable with a prior art valve at any non-zero damper angle to the air flow direction. This permits fuel optimization over an increased range of engine speeds.

### BRIEF DESCRIPTION OF THE DRAWINGS

The present invention will now be described, by way of example, with reference to the accompanying drawings, in which:

FIG. 1 a schematic cross-sectional view of a prior art tumble valve in a fully-closed (maximum tumble) position in a manifold runner;

FIG. 2 is a view like that shown in FIG. 1, showing the prior art valve in a fully-open position;

FIG. 3 is a cross-sectional view of an intake manifold runner provided with an improved tumble valve in accordance with the invention;

FIG. 4 is a schematic cross-sectional view of a tumble valve in accordance with the invention in a range of tumble-producing positions in a manifold runner; and

FIG. 5 is a view like that shown in FIG. 4, showing the improved valve in a fully-open position.

### DESCRIPTION OF THE PREFERRED EMBODIMENTS

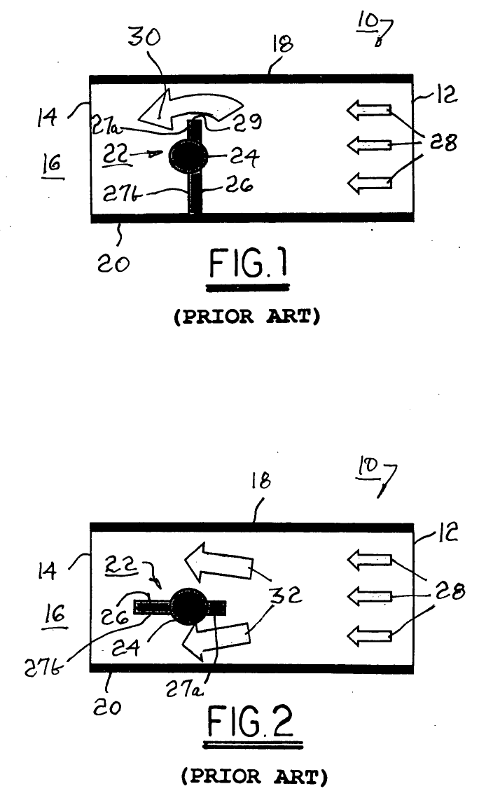

Referring to FIGS. 1 and 2, a portion of a prior art manifold runner 10 includes an air inlet end 12 and an air outlet end 14. Typically, outlet end 14 is immediately adjacent an intake valve (not shown) to a combustion cylinder of an internal combustion engine 16. Runner 10 includes first and second walls 18,20, referred to herein as upper and lower walls, respectively, as that is their orientation typically when installed in engine 16. Obviously, runner 10 also includes sidewalls to complete the air flow passage (only sidewall 19 is visible in cross-sectional FIGS. 1 and 2). Within runner 10 is a tumble valve 22 comprising a rotatable cross-shaft 24 extending through the sidewalls and supporting a butterfly damper 26. Damper 26 includes portions 27a and 27b extending in opposite directions from shaft 24. Shaft 24 may be rotated through an angle of about 90° between the extremes shown in FIGS. 1 and 2 to either occlude a majority of the flow air flow path (FIG. 1) or maximize the air flow path (FIG. 2). Air 28 flowing through runner 10 upstream of valve 22 may be substantially laminar, or at least exhibit relatively little turbulence. Upon encountering valve 22, which when closed is essentially a weir 29 creating a pressure drop, air 28 is compressed and accelerated as it tumbles 30 turbulently over butterfly damper 26. Portion 27b engages wall 20 to shut off air flow therealong.

As already mentioned above, a shortcoming of a prior art tumble valve such as valve 22 is that even when wide open, as shown in FIG. 2, it presents a significant impediment to flow 32 of air through runner 10 because the entire valve mechanism is disposed within the air flow path.

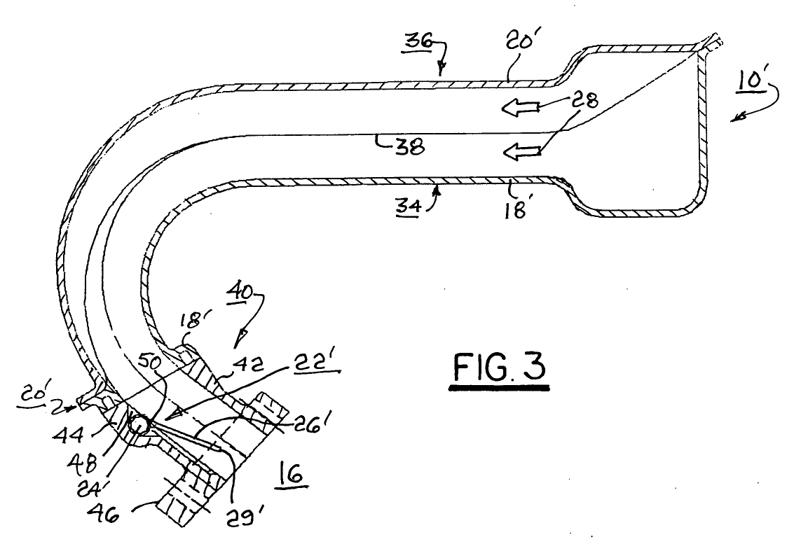

Referring to FIGS. 3 through 5, an intake manifold runner 10′ in accordance with the invention comprises first and second walls 18′,20′ which are components of first and second runner shells 34,36 joinable along interface 38. (When shells 34,36 are joined, manifold runner 10′ also forms third and fourth opposing walls of which only opposing wall 19′ is visible in FIG. 3). Runner 10′ includes a tumble valve sub-assembly 40 including an improved tumble valve 22′. Sub-assembly 40 comprises first and second walls 42,44, contiguous with walls 18′,20′, respectively, and a mounting flange 46 for connection to engine 16. Wall 44 is provided with a first transverse recess 48 for receiving a transverse pivot-shaft 24′ disposed in sidewalls (not visible in FIG. 3) of sub-assembly 40 and substantially out of the air flow path through runner 10′. A butterfly damper 26′ is attached along a first edge 50 thereof to shaft 24′, a second edge thereof defining a tumble weir 29′ for air 30′ passing by damper 26′. Preferably, a second recess 52 is formed in wall 44 for receiving damper 26′ when the valve is in the open position such that shaft 24′ and damper 26′ are substantially out of the air flow path and present no parasitic resistance to non-tumbled air flow 32′. Valve 22′ may be mounted such that the pivot shaft 24′ is either upstream or downstream of damper 26′, although in a presently preferred embodiment the shaft is upstream of the damper, as shown in FIGS. 3-5; thus the default position for the valve is wide open.

Preferably, the cross-sectional shape of valve sub-assembly 40 is generally rectangular, as is the plan shape of damper 26′, to permit the damper to lie flat against, or within a recess in, wall 44.

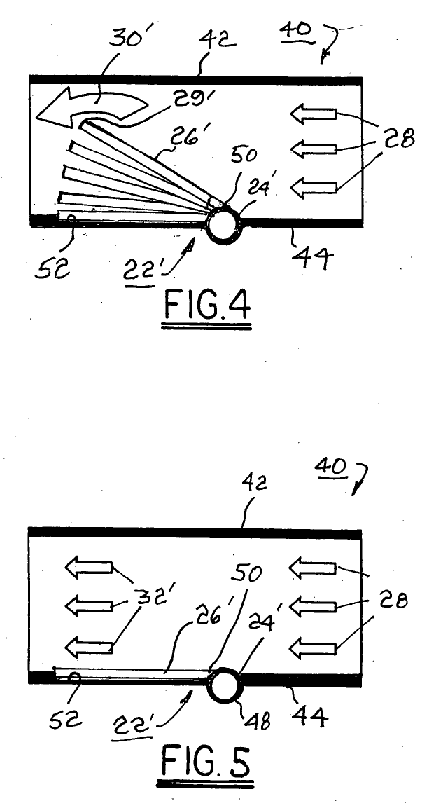

A distinguishing feature of a tumble valve in accordance with the invention is that the shaft is disposed in the sidewalls of the runner or sub-assembly such that no air flow is permitted between the shaft and wall 44 at any position of the damper 26′. Thus damper 26′ has no counterpart to prior art butterfly portion 27b, and all the air passing through the runner passes between shaft 24′ and wall 42. The degree of tumble provided by valve 22′ may be continuously varied by varying the open angle of the valve between about 0° (fully open, FIG. 5) and any other angle (partially closed, FIGS. 3 and 4) up to about 90°, depending upon the length of damper 26′.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. A runner for an intake manifold in an internal combustion engine, the runner comprising:
a) first and second opposed walls and third and fourth opposed walls for conducting air through said runner; and
b) a tumble valve assembly for creating turbulence in said air being conducted through said runner, said valve assembly having a pivot-shaft pivotably disposed in said third and fourth walls and having a damper attached to said pivot-shaft, said pivot-shaft and damper being disposed adjacent one of said first and second walls, such that all of said conducted air passes between said pivot-shaft and damper and the other of said first and second walls.

2. A runner in accordance with claim 1 wherein said one of said first and second walls adjacent said pivot-shaft is provided with a first transverse recess for receiving said pivot shaft.

3. A runner in accordance with claim 2 wherein said wall having said first recess is provided with a second transverse recess for receiving said damper when said valve is in an open position.

4. A runner in accordance with claim 1 wherein air tumble may be varied by varying a pivot angle of said pivot-shaft.

5. A runner in accordance with claim 1 wherein said runner is rectanguloid in cross-sectional shape and said damper is rectanguloid in plan shape.

6. An intake manifold for an internal combustion engine, comprising at least one runner having
first and second opposed walls and third and fourth opposed walls for conducting air through said runner, and
a tumble valve assembly for creating turbulence in said air being conducted through said runner, said valve assembly having a pivot-shaft pivotably disposed in said third and fourth walls and having a damper attached to said pivot-shaft, said pivot-shaft and damper being disposed adjacent one of said first and second walls, such that all of said conducted air passes between said pivot-shaft and damper and the other of said first and second walls.

7. An internal combustion engine comprising at least one intake manifold runner, wherein said at least one runner includes
first and second opposed walls and third and fourth opposed walls for conducting air through said runner, and
a tumble valve assembly for creating turbulence in said air being conducted through said runner, said valve assembly having a pivot-shaft pivotably disposed in said third and fourth walls and having a damper attached to said pivot-shaft, said pivot-shaft and damper being disposed adjacent one of said first and second walls, such that all of said conducted air passes between said pivot-shaft and damper and the other of said first and second walls.
